(19) United States
(12) Patent Application Publication
(10) Pub. No.: US 2024/0419171 A1
(43) Pub. Date: Dec. 19, 2024

(54) DOCKING SYSTEM, AUTONOMOUS MOBILE ROBOT FOR USE WITH SAME, AND ASSOCIATED METHOD

(71) Applicant: Ford Global Technologies, LLC, Dearborn, MI (US)

(72) Inventors: Sanghyun Hong, Ann Arbor, MI (US); Kurt Michael Lundeen, Novi, MI (US)

(73) Assignee: Ford Global Technologies, LLC, Dearborn, MI (US)

(21) Appl. No.: 18/333,547

(22) Filed: Jun. 13, 2023

(51) Int. Cl. G05D 1/02

(52) U.S. Cl. CPC G05D 1/0225

(57) ABSTRACT

A docking system is provided. The docking system includes a docking station and an autonomous mobile robot (AMR). The AMR includes a body, a mount movably coupled to the body, a sensor coupled to the mount and having a field-of-view, a processor, and a memory. The memory includes instructions that, when executed by the processor, cause the processor to perform operations including employ the sensor to scan the docking station, cause the mount to move independently with respect to the body in order to center the field-of-view on the docking station, and dock the AMR at the docking station using the centered field-of-view.

### BACKGROUND

Autonomous Mobile Robots (AMRs) are commonly used in the transportation ecosystem in order to meet the demand of delivery due to increased online shopping. In the transportation ecosystem, navigation software for AMRs are configured to allow the AMRs to dock at docking stations (e.g., battery stations for battery charging/replacement and package lockers for package loading/unloading).

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is an isometric view of a docking system, shown with portions of the docking station removed, in accordance with one non-limiting embodiment of the disclosed concept.

FIG. 2 is a simplified view of the docking system of FIG. 1.

FIG. 3 is a schematic of another docking system, shown with an autonomous mobile robot (AMR) attempting to dock at a docking station, and with portions of the docking station removed.

FIG. 4 shows the docking system of FIG. 3, with a mount having moved independently with respect to a body of the AMR.

FIG. 5 shows a schematic of another docking system, in accordance with another non-limiting embodiment of the disclosed concept.

FIG. 6 shows the docking system of FIG. 5, with a mount having moved independently with respect to a body of the AMR.

FIG. 7 shows a simplified view of another docking system, in accordance with another non-limiting embodiment of the disclosed concept.

FIG. 8 is a flow chart corresponding to control of an autonomous mobile robot, in accordance with embodiments of the disclosed concept.

### DETAILED DESCRIPTION

### Overview

The systems, apparatuses, and methods disclosed herein assist at least in part in precisely docking an autonomous mobile robot (AMR) with a docking station. In one example, the AMR includes a body, a mount that is movably coupled to the body, and a sensor coupled to the mount and having a field of view. The mount may be configured to rotate on an axis with respect to the body of the AMR, or may translate across a surface of the body of the AMR. Additionally, the AMR may have a processor that may employ the sensor to scan the docking station, cause the mount to move independently with respect to the body in order to center the field-of-view (e.g., the area in which the scanning elements of the sensor are focused) on the docking station, and dock the AMR at the docking station using the centered field-of-view.

Accordingly, the independently movable sensor allows the AMR to better dock, at least in that once the sensor scans the docking station, it can move with respect to the body of the AMR and center its field-of-view on the docking station. This may allow offset and final positions of the AMR to better be determined, thereby allowing the AMR to dock at the docking station with even greater precision.

In one example, the sensor is either a camera or a LiDar sensor. In another example, the AMR includes both a camera and a LiDar sensor, and each are coupled to a single mount that is movably coupled to (e.g., may rotate about an axis with respect to) a body of the AMR. In yet a further example, the AMR includes both a camera and a LiDar sensor, as well as two spaced apart mounts, each movably coupled to the body of the AMR and a corresponding one of the camera and the LiDar sensor. Furthermore, the AMR, the docking station, and surrounding structures may include a number of stationary sensors that are configured to send data to the processor of the AMR to assist with precise docking. In this manner, the AMR is advantageously provided with a robust amount of data to assist it during docking.

More specifically, typical AMRs dock with the assistance of one or more stationary sensors (e.g., sensors that are fixed with respect to bodies of the AMRs). In accordance with the disclosed concept, when the AMR is moving, e.g., in a warehouse, and is attempting to dock, it is critical that the AMR be precisely aligned with the docking station. By having independently movable mounts on which the cameras and/or the LiDar sensors are mounted, better alignment is possible. Additionally, once such a camera and/or LiDar sensor scans any portion of a docking station (or other structure indicative of where a position of the docking station may be), that camera or LiDar sensor can move independently with respect to a body of the AMR and better focus on a center of the structure of the docking station. This can be done while the body of the AMR is still attempting to turn and be properly aligned. As such, better alignment between the AMR and the docking station will ultimately result because at least a portion of the AMR (e.g., the camera and/or LiDar sensor which has been turned with respect to the body of the AMR) will be focusing its field-of-view on a center of the docking station, and in real time transmitting this data to the processor of the AMR to allow it to precisely dock.

These and other advantages of the present disclosure are provided in greater detail herein.

### Illustrative Embodiments

As employed herein, the term “coupled” shall mean connected together either directly or via one or more intermediate parts or components.

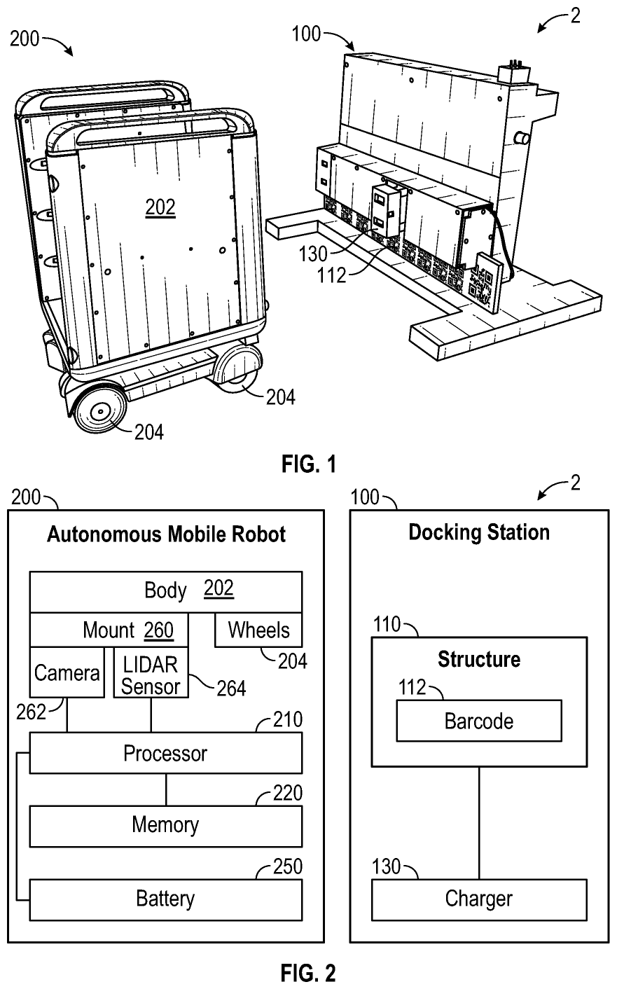

FIG. 1 shows a docking system 2, in accordance with one non-limiting embodiment of the disclosed concept. The docking system 2 includes a docking station 100 and an autonomous mobile robot (e.g., AMR 200, also shown in FIG. 2) configured to move independently with respect to the docking station 100. The AMR 200 may include a body 202 and a plurality of wheels 204 coupled to the body 202 and configured to allow the body 202 to roll on a surface. Additionally, the AMR 200 may be configured to dock at the docking station 100 for a number of reasons, including re-charging and/or replacement of a battery 250 (FIG. 2), and package loading and unloading. When the AMR 200 is docking at the docking station 100, it is important that the AMR 200 be precisely aligned with the docking station 100. In accordance with the disclosed concept, the docking system 2 advantageously provides for relatively precise docking between the AMR 200 and the docking station 100.

FIG. 2 shows a simplified view of the docking system 2. As shown, the docking station 100 includes a structure 110 having a barcode 112, and a charger 130 coupled to the structure 110 and configured to charge the battery 250 of the AMR 200. Continuing to refer to FIG. 2, the AMR 200 further includes a processor 210, a memory 220, and the battery 250 electrically connected to the processor 210. In one example, the charger 130 (see also FIG. 1) of the docking station 100 may be configured to charge the battery 250 of the AMR 200, for example when the AMR 200 is in a docked position, with respect to the docking station 100. In another example, the docking station 100 may also and/or additionally be configured to replace the battery 250 of the AMR 200. In accordance with the disclosed concept, the AMR 200 is advantageously configured for precise docking with respect to the docking station 100.

More specifically, in one example the AMR 200 further includes a mount 260 movably coupled to the body 202, and a number of sensors movably coupled to the body 202. In one example, the sensors are fixedly coupled to the mount 260. Additionally, in the example of FIG. 2, the sensors are in the form of a camera 262 and a LiDar sensor 264 each movably coupled to the body 202, and each having a field-of-view. Furthermore, in one example the memory 220 of the AMR 200 may include instructions that, when executed by the processor 210, cause the processor 210 to perform operations including employ either or both of the camera 262 and the LiDar sensor 264 to scan the docking station 100, cause the mount 260 to move independently with respect to the body 202 in order to center the field-of-view on the docking station 100, and dock the AMR 200 at the docking station 100 using the centered field-of-view. That is, when the AMR 200 is moving in order to dock at the docking station 100, its position changes from a first position to a second position based on the centered field-of-view.

In other words, the AMR 200 changes course from a first course to a second course, wherein the second course coincides with a central axis of the field-of-view of either or both of the sensors 262,264 (e.g., an axis perpendicular to a center of a lens of one of the sensors 262,264). This may occur even while the body 202 and the wheels 204 of the AMR are still pointing at a location of the structure 110 offset from its center (e.g., are moving in a course different than the aforementioned second course). In such a scenario, the body 202 and the wheels 204 move to align with the already centered field-of-views of the sensors 262,264. By having the field-of-views of the camera 262 and/or the LiDar sensor 264 be centered with respect to the docking station 100, when the AMR 200 is turned, data and images captured by the camera 262 and/or the LiDar sensor 264 will be significantly less blurry, as compared with other typical AMRs.

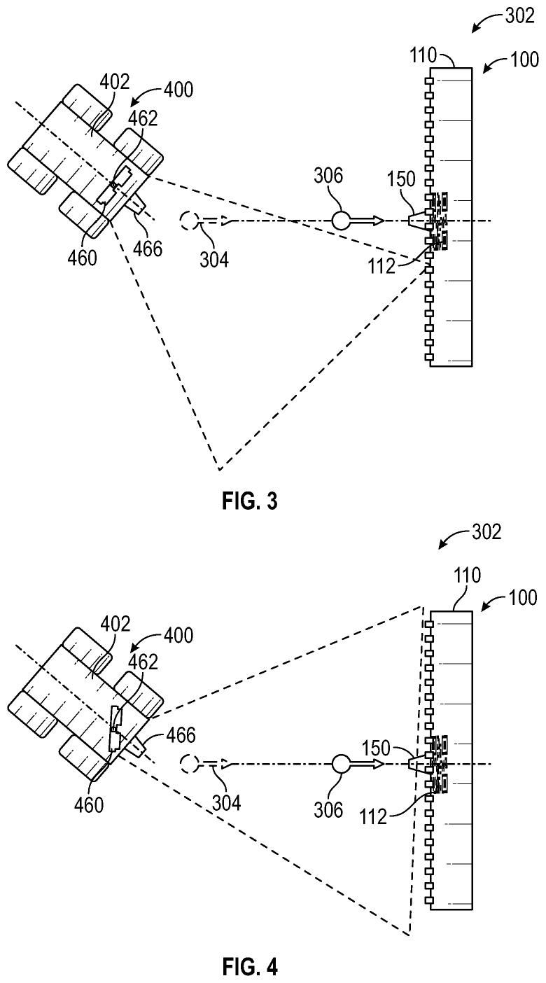

The aforementioned advantages of the disclosed concept can further be appreciated with reference to FIG. 3, which shows another docking system 302 similar to the docking system 2, wherein like numbers represent like features. As shown, the docking system 302 includes the docking station 100 and the AMR 400, which is attempting to dock at the docking station 100. As shown in FIG. 3, the field-of-view of the camera 462 (shown in simplified form in FIG. 3) is offset with respect to the docking station 100. However, when the camera 462 scans the docking station 100, the mount 460 is caused to move independently with respect to the body 402 in order to center the field-of-view on the docking station 100. Compare, for example, the position of the mount 460 in FIG. 3 versus FIG. 4, wherein the mount 460 has moved with respect to the body 402 such that the field-of-view of the camera 462 is centered on the docking station 100 (e.g., a center of the camera is pointed and/or aligned with a center of the structure 110). Additionally, as stated above, the structure 110 has a barcode 112, and in one example, the camera 462 is configured to be centered with respect to the barcode 112. Accordingly, the processor of the AMR 400 provides for tracking of the barcode 112 while docking.

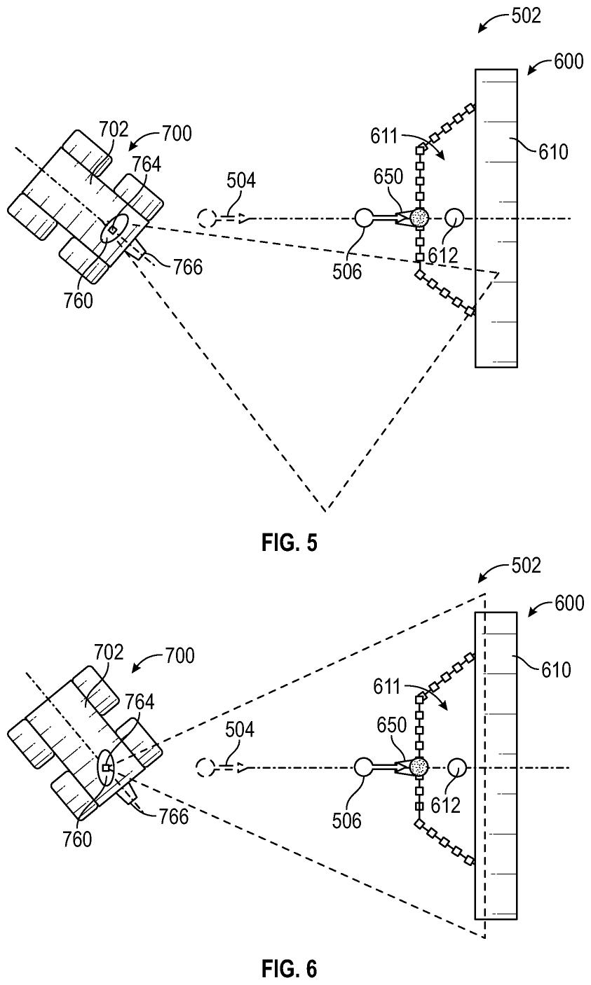

FIGS. 5 and 6 show another docking system 502 similar to the docking system 2, wherein like numbers represent like features. As shown, the docking system 502 includes the docking station 600 and the AMR 700, which is attempting to dock at the docking station 600. As shown in FIG. 5, the mount 760 is movably coupled to the body 702, and the LiDar sensor 764 is coupled to the body and has a field-of-view that is offset with respect to the docking station 600. This may correspond to the AMR 700 attempting to dock at the docking station 600, and not being aligned with the docking station 600 during docking. In accordance with the disclosed concept, the mount 760 is configured to move independently with respect to the body 702 (e.g., to rotate about an axis in the example of FIGS. 5 and 6) in order to center the field-of-view on the structure 610. In another example, the mount 760 may be configured to translate about a top surface of the body 702.

In the example of FIGS. 5 and 6, the docking station includes an element 611 coupled to the structure 610, and the element 611 has a middle point 612 (e.g., a geometric center of the element 611). Accordingly, once the LiDar sensor 764 detects (e.g., scans) the element 611, as shown in FIG. 5, the mount 760 is configured to move independently with respect to the body 702 in order to center the field-of-view on the middle point 612, as shown in FIG. 6. In one particular example, the element 611 has a unique geometry that is stored in the processor of the AMR 700, thereby allowing the AMR 700 recognize the element 611 and dock with precision.

While the examples of FIGS. 3-6 have been described in association with the camera 462 being coupled to the mount 460 and the LiDar sensor 764 being coupled to the mount 760, it will be appreciated that other suitable embodiments are contemplated. For example, the mount 260 of the AMR 200 in FIG. 2 is configured to move independently with respect to the body 202 in order to center either or both of the field-of-views of the camera 262 and the LiDar sensor 264 on the structure 110. The camera 262 may further be configured to scan the barcode 112 and center the field-of-view on the barcode 112. In other words, the processor 210 causing the mount 260 to move independently with respect to the body 202 includes centering the field-of-view of either or both of the camera 262 and the LiDar sensor 264 on the barcode 112.

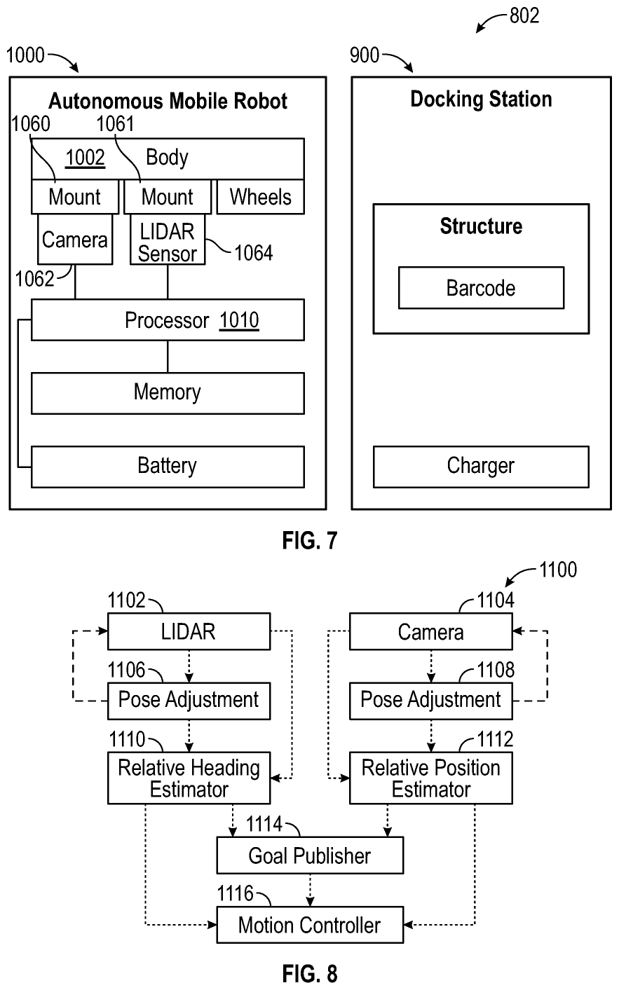

Additionally, FIG. 7 shows another example docking system 802 similar to the docking system 2 (FIGS. 1 and 2), wherein like numbers represent like features. As shown, the AMR 1000 has first and second mounts 1060,1061 that are each movably coupled to the body 1002, and are spaced from one another. Additionally, the camera 1062 and the LiDar sensor 1064 are each coupled to a corresponding one of the first and second mounts 1060,1061 and are preferably spaced from one another. As a result, the AMR 1000 is advantageously configured such that both the camera 1062 and the LiDar sensor 1064 can independently provide docking data to the processor 1010 of the AMR 1000 in order to allow the AMR 1000 to be precisely docked. That is, the camera 1062 and the LiDar sensor 1064 are each configured to scan the docking station, and the mounts 1060,1061 are configured to move independently with respect to the body 1002 in order to center the field-of-views of the camera 1062 and the LiDar sensor 1064 on the docking station.

In order to dock the AMRs 200,400,700,1000, in one example the memories of the AMRs 200,400,700, 1000 include instructions that, when executed by the processors 210 of the AMRs 200,400,700,1000 cause the processors 210 of the AMRs 200,400,700,1000 to: a) employ the sensors 262,264,462,764, 1062, 1064 to determine an offset position 304,504 (FIGS. 3-6) and a final position 306,506 (FIGS. 3-6) of the AMRs 200,400,700,1000 with respect to the docking stations 100,600,900 based on the centered field-of-view, and b) dock the AMRs 200,400,700,1000 at the docking stations 100,600,900 using the offset and final positions 304,306,504,506.

In this manner, the movably mounted sensors 262,264,462,764,1062,1064 provide additional data to the processors 210 of the AMRs 200,400,700,1000 to allow them to precisely dock. For example, and referring again to FIGS. 3 and 4, the docking station 100 may further include a stationary camera 150 coupled to (e.g., is configured not to move with respect to) the structure 110, and the AMR 400 may further include a stationary camera 466 coupled to (e.g., is configured not to move with respect to) the body 402. In one example embodiment, either or both of the stationary cameras 150,466 provide relative position data to the processor of the AMR 400 in order to allow the offset and final positions 304,306 to be precisely determined, and also to supplement the data provided to the processor of the AMR by the camera 462. As such, the AMR 400 has a robust amount of data supplied to its processor that allow it to precisely dock with the docking station 100. FIGS. 5 and 6 may be similarly structured (e.g., stationary cameras 650,766 are coupled to the unique element 611 and the body 702, respectively) in order to provide even more robust data to the processor of the AMR 700, thereby allowing the offset and final positions 504,506 to be determined with greater accuracy.

Additionally, when the mounts 260,460,760,1060,1061 move independently with respect to the bodies 202,402, 702,1002 of the AMRs 200,400,700,1000, it will be appreciated that yaw, pitch, and roll angles of the corresponding sensors 262,264,462,764, 1062, 1064 are changed, thus allowing better position data of the docking stations 100,600,900 to be sent to the processors 210 of the AMRs 200,400,700,1000.

In one example embodiment, a method of docking an autonomous mobile robot (AMR) 200,400,700,1000 at a docking station 100,600,900 is provided. The method includes providing the docking station 100,600,900, providing the AMR 200,400,700,1000 with a body 202,402,702,1002, a mount 260,460,760,1060,1061 movably coupled to the body 202,402,702,1002, and a sensor 262,264,462,764,1062,1064 coupled to the mount 260,460,760, 1060,1061 and having a field-of-view, scanning the docking station 100,600,900 with the sensor 262,264,462,764,1062,1064, moving the mount 260,460,760,1060, 1061 independently with respect to the body 202,402,702,1002 in order to center the field-of-view on the docking station 100,600,900 and docking the AMR 200,400,700,1000 at the docking station 100,600,900 using the centered field-of-view. The method may further include determining an offset and a final position 304,306,504,506 of the AMR 200,400,700,1000 with respect to the docking station 100,600,900, and using the offset and final positions 304,306,504,506 to dock the AMR 200,400,700,1000 at the docking station 100,600,900.

FIG. 8 is a flow chart 1100 corresponding to control of an autonomous mobile robot, in accordance with one non-limiting embodiment of the disclosed concept. As shown, a LiDar sensor 1102 and a camera 1104 may have their positions commanded by pose adjustment modules 1106 and 1108, respectively, which send relative headings and positions to heading estimators 1110,1112, which send data to a goal publisher 1114, which then may send data to a motion controller 1116 of the autonomous mobile robot. Accordingly, relative position adjustments of the LiDar sensor 1102 and the camera 1104 correlate to more accurate data being sent to the motion controller 1116, as compared to typical AMRs, which may have sensors that are fixed with respect to the bodies on which they are mounted.

It will thus be appreciated that the AMR processes point cloud data from the LiDar sensor 1102 and the LiDar's position to determine the relative heading alignment between the AMR and the docking station. Additionally, the AMR processes the matrix-barcode image and camera's 1104 pose to determine the relative position (i.e., x, y coordinates) with respect to the docking station. The estimated relative heading and position are used to determine offset and final positions, and they are also used as feedback for the motion controller 1116.

The processors 210,1010 of the AMRs 200,400,700,1000 may be a commercially available general-purpose processor, such as a processor from the Intel® or ARM® architecture families. The memories 220 of the AMRs 200,400,700,1000 may be a non-transitory computer-readable memory storing program code, and can include any one or a combination of volatile memory elements (e.g., dynamic random access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

It will also be understood herein that operations described herein should always be implemented and/or performed in accordance with the owner manual and safety guidelines.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A docking system, comprising:
a docking station; and
an autonomous mobile robot (AMR) comprising:
a body,
a mount movably coupled to the body,
a sensor coupled to the mount and having a field-of-view,
a processor, and
a memory comprising instructions that, when executed by the processor, cause the processor to perform operations comprising:
employ the sensor to scan the docking station,
cause the mount to move independently with respect to the body in order to center the field-of-view on the docking station, and
dock the AMR at the docking station using the centered field-of-view.

2. The docking system according to claim 1, wherein the memory further comprises instructions that, when executed by the processor, cause the processor to perform the operation comprising employ the sensor to determine an offset position and a final position of the AMR with respect to the docking station based on the centered field of view, and wherein dock the AMR at the docking station is performed using the offset and final positions.

3. The docking system according to claim 2, wherein the sensor is a first sensor, wherein the AMR further comprises a second sensor coupled to the mount and having a field-of-view, wherein the memory further comprises instructions that, when executed by the processor, cause the processor to perform the operation comprising employ the second sensor to scan the docking station, and wherein cause the mount to move independently with respect to the body is further performed in order to center the field-of-view of the second sensor on the docking station.

4. The docking system according to claim 3, wherein the first sensor is a camera, and wherein the second sensor is a LiDar sensor.

5. The docking system according to claim 4, wherein the mount is a first mount, wherein the AMR further comprises a second mount and a second sensor coupled to the second mount and having a field-of-view, wherein the second mount is movably coupled to the body, and wherein the memory further comprises instructions that, when executed by the processor, cause the processor to perform operations comprising employ the second sensor to scan the docking station, and cause the second mount to move independently with respect to the body in order to center the field-of-view of the second sensor on the docking station.

6. The docking system according to claim 5, wherein the first sensor is a camera, and wherein the second sensor is a LiDar sensor.

7. The docking system according to claim 6, wherein the first mount is spaced from the second mount.

8. The docking system according to claim 2, wherein the sensor is a camera, wherein the docking station comprises a structure having a barcode, and wherein cause the mount to move independently with respect to the body comprises center the field-of-view on a center of the barcode.

9. The docking system according to claim 2, wherein the sensor is a LiDar sensor, wherein the docking station comprises an element having a middle point, and wherein cause the mount to move independently with respect to the body comprises center the field-of-view on the middle point.

10. An autonomous mobile robot (AMR) configured to dock at a docking station, the AMR comprising:
a body;
a mount movably coupled to the body;
a sensor coupled to the mount and having a field-of-view;
a processor; and
a memory comprising instructions that, when executed by the processor, cause the processor to perform operations comprising:
employ the sensor to scan the docking station, and
cause the mount to move independently with respect to the body in order to center the field-of-view on the docking station.
dock the AMR at the docking station using the centered field-of-view.

11. The AMR according to claim 10, wherein the sensor is a first sensor, wherein the AMR further comprises a second sensor coupled to the mount and having a field-of-view, wherein the memory further comprises instructions that, when executed by the processor, cause the processor to perform the operation comprising employ the second sensor to scan the docking station, and wherein cause the mount to move independently with respect to the body is further performed in order to center the field-of-view of the second sensor on the docking station.

12. The AMR according to claim 11, wherein the first sensor is a camera, and wherein the second sensor is a LiDar sensor.

13. The AMR according to claim 11, wherein the mount is a first mount, wherein the AMR further comprises a second mount and a second sensor coupled to the second mount and having a field-of-view, wherein the second mount is movably coupled to the body, and wherein the memory further comprises instructions that, when executed by the processor, cause the processor to perform operations comprising employ the second sensor to scan the docking station, and cause the second mount to move independently with respect to the body in order to center the field-of-view of the second sensor on the docking station.

14. The AMR according to claim 13, wherein the first sensor is a camera, wherein the second sensor is a LiDar sensor, and wherein the first mount is spaced from the second mount.

15. A method of docking an autonomous mobile robot (AMR) at a docking station, the method comprising:
providing the docking station;
providing the AMR with a body, a mount movably coupled to the body, and a sensor coupled to the mount and having a field-of-view;
scanning the docking station with the sensor;
moving the mount independently with respect to the body in order to center the field-of-view on the docking station; and
docking the AMR at the docking station using the centered field-of-view.

16. The method according to claim 15, further comprising determining an offset position and a final position of the AMR with respect to the docking station based on the centered field of view, and wherein docking the AMR at the docking station is performed using the offset and final positions.

17. The method according to claim 16, wherein the sensor is a first sensor, wherein the AMR further comprises a second sensor coupled to the mount and having a field-of-view, wherein the method further comprises scanning the docking station with the second sensor, wherein moving the mount independently with respect to the body is further performed in order to center the field-of-view of the second sensor on the docking station, wherein the first sensor is a camera, and wherein the second sensor is a LiDar sensor.

18. The method according to claim 17, wherein the mount is a first mount, wherein the AMR further comprises a second mount and a second sensor coupled to the second mount and having a field-of-view, wherein the second mount is movably coupled to the body, wherein the method further comprises scanning the docking station with the second sensor and moving the second mount independently with respect to the body in order to center the field-of-view of the second sensor on the docking station, wherein the first sensor is a camera, wherein the second sensor is a LiDar sensor, and wherein the first mount is spaced from the second mount.

19. The method according to claim 16, wherein the sensor is a camera, wherein the docking station comprises a structure having a barcode, and wherein moving the mount independently with respect to the body comprises centering the field-of-view on a center of the barcode.

20. The method according to claim 16, wherein the sensor is a LiDar sensor, wherein the docking station comprises an element having a middle point, and wherein moving the mount independently with respect to the body comprises centering the field-of-view on the middle point.
